(19) United States
(12) Patent Application Publication
(10) Pub. No.: US 2023/0378847 A1
(43) Pub. Date: Nov. 23, 2023

(54) ELECTRICAL MACHINE HAVING A BEARING OF A CONNECTION SHAFT CONNECTED TO A ROTOR

(71) Applicant: Schaeffler Technologies AG & Co. KG, Herzogenaurach (DE)

(72) Inventors: Dirk Reimnitz, Buhl (DE); Ivo Agner, Buhl (DE); Stefan Riess, Kaufering (DE)

(73) Assignee: Schaeffler Technologies AG & Co. KG, Herzogenaurach (DE)

(21) Appl. No.: 18/030,653

(22) PCT Filed: Oct. 7, 2021
(86) PCT No.: PCT/DE2021/100810

§ 371 Date: Apr. 6, 2023

(30) Foreign Application Priority Data
Oct. 7, 2020 (DE) 102020126310.4
Aug. 24, 2021 (DE) 102021121910.8

(51) Int. Cl. H02K 7/08; H02K 7/00; H02K 5/173; H02K 15/02

(52) U.S. Cl. CPC H02K 7/085; H02K 7/006; H02K 5/173; H02K 15/02

(57) ABSTRACT

An electrical machine for a motor vehicle drive, including a housing, a stator, which is accommodated in the housing, and a rotor, which is connected to a connection shaft for conjoint rotation. The connection shaft is radially and axially supported toward a first axial side of the rotor by a double-row rolling bearing assembly and is supported on the housing side, with respect to a second axial side of the rotor opposite the first axial side, by an additional rolling bearing designed at least to transmit axial forces.

### CROSS-REFERENCE TO RELATED APPLICATIONS

This application is the U.S. National Phase of PCT Appln. No. PCT/DE2021/100810, filed Oct. 7, 2021, which claims the benefit of German Patent Appln. No. 102021121910.8, filed Aug. 24, 2021 and German Patent Appln. No. 102020126310.4, filed Oct. 7, 2020, the entire disclosures of which are incorporated by reference herein.

### TECHNICAL FIELD

The disclosure relates to an electrical machine for a motor vehicle drive, preferably an electrical machine, connected upstream of a transmission of a motor vehicle drive train. The motor vehicle can be implemented as a purely electrically driven or hybrid driven motor vehicle.

### BACKGROUND

In the case of electrical machines used in vehicle drive trains, a fundamental requirement exists to keep the position of a rotor relative to a stator as constant as possible during operation. This is made particularly difficult by the dynamic processes in the motor vehicle drive, which directly influence the axial and radial position of the rotor or the connection shaft, which is further connected to the rotor. This can lead to an axial and/or radial displacement and/or tilting of the rotor relative to the stator, in particular when the motor vehicle drive is subjected to high loads. The resulting change in the existing air gaps between the rotor and stator in turn leads to losses in the efficiency of the electrical machine.

### SUMMARY

It is therefore the object of the present disclosure to provide an electrical machine that is as efficient as possible even under high dynamic loads of the motor vehicle drive.

This is achieved according to the disclosure.

More specifically, the electrical machine is equipped with a housing, a stator accommodated in the housing and a rotor, which is connected to a connection shaft for conjoint rotation. The connection shaft is further radially and axially supported toward a first axial side of the rotor, preferably on the housing side or on the output side, by means of a double-row rolling bearing assembly and is supported on the housing side toward a second axial side of the rotor facing away from the first axial side by means of an additional rolling bearing designed at least to transmit axial forces.

The rolling bearing assembly can be fastened directly to the stator or a stator housing of the stator or to a main housing body or a further housing. Preferably, the rolling bearing assembly is fastened to the stator.

This mounting of the connection shaft relative to the housing, preferably a housing-integrated stator housing, means that the connection shaft with the rotor is supported much more robustly against displacement and against tilting relative to the stator. This significantly increases the efficiency of the electrical machine.

Further advantageous embodiments are disclosed in greater detail below.

Accordingly, it is also advantageous if the rolling bearing assembly is formed as a double-row rolling bearing, preferably as a double-row rolling bearing with a single-piece outer or inner ring (forming two axially neighboring (first and third) rolling element raceways). As a result, the rolling bearing assembly is implemented in a manner that is as stable as possible.

Alternatively, it is also advantageous if the rolling bearing assembly is formed by two single-row rolling bearings arranged directly axially adjacent to one another, preferably with their outer rings and inner rings in direct axial contact. This significantly reduces the manufacturing effort required for the rolling bearing assembly.

In this respect, it has also proved advantageous if the rolling bearing assembly is designed as a double-row angular contact ball bearing or two single-row angular contact ball bearings or a double-row tapered roller bearing or two single-row tapered roller bearings or a combination of an angular contact ball bearing and a tapered roller bearing.

If multiple rolling element raceways of the rolling bearing assembly are aligned with one another in an O arrangement or X arrangement, this results in a particularly stable mounting of the connection shaft.

For an even more robust mounting of the connection shaft, it is further advantageous if the rolling bearing assembly has at least one outer ring fixed both radially and axially, preferably axially on both sides, to the stator, for example to a stator housing accommodating the stator, and/or has at least one inner ring fixed both radially and axially (preferably axially on both sides) to the connection shaft.

In addition, it is advantageous if the additional rolling bearing enters into a radial clearance fit on its outer ring or on its inner ring on the part of the stator, preferably to a stator housing accommodating the stator, or the connection shaft. As a result, the additional rolling bearing is implemented as soft in the radial direction in a targeted manner in order to avoid distortion with the rolling bearing assembly.

In this respect, it has also proved advantageous if the additional rolling bearing is designed as an angular contact ball bearing or a tapered roller bearing.

It is also advantageous if rolling element raceways or force transmission directions of the additional rolling bearing are opposite with respect to rolling element raceways or force transmission directions of the rolling element assembly. This results in a particularly stable mounting of the connection shaft with the rotor. Thus, the additional rolling bearing can be opposed to one of the rolling bearing raceways of the rolling bearing assembly.

The rolling bearing assembly and the additional rolling bearing further preferably serve to directly mount the connection shaft on a stator housing further connected to another main housing body of the housing.

It is also advantageous if a direct contact region between a support wall of the stator housing and the main housing body is arranged axially offset from the stator. This provides a robust fastening of the stator housing to the main housing body.

If the electrical machine is designed as an axial flux machine, the robust support between the rotor and stator according to the disclosure has a particularly decisive effect on the efficiency of the electrical machine.

Accordingly, it is further advantageous if the stator has two disc-shaped stator halves each having at least one coil body, wherein each stator half is accommodated in the stator housing and the disc-shaped rotor is arranged axially between the stator halves.

Furthermore, it is advantageous if a support wall of the stator housing is fastened to the main housing body by means of at least one fastening element. The at least one fastening element, preferably in the form of a screw, is further preferably aligned in its longitudinal direction or with its longitudinal axis parallel to an axis of rotation of the rotor. Alternatively, it is also considered expedient if the at least one fastening element is aligned in its longitudinal direction or with its longitudinal axis perpendicular to an axis of rotation of the rotor.

In other words, a stable rotor shaft mounting for an electric motor or electrical machine is thus implemented. In the electrical machine, in particular an electrical axial flux machine, the rotor shaft (connection shaft) is mounted on one side of the rotor by means of a double-row bearing (rolling bearing assembly; e.g., a double-row angular contact ball bearing) or two neighboring bearings. This mounting prevents radial movements, axial movements and undesired tilting movements of the rotor shaft or limits them to a very small extent. On the other side of the rotor shaft, the rotor shaft is mounted in a further bearing (additional rolling bearing) which transmits at least axial forces (e.g., a single-row angular contact ball bearing, possibly with a radial clearance fit on the inner or outer ring).

If the rotor shaft is mounted by means of angular contact ball bearings, tapered roller bearings or other bearings with a force transmission direction oblique to the axis of rotation of the bearings (for example, caused by the contact angle or pressure angle of the rolling elements in rolling contact with the rolling element raceways), it is expedient that the bearing point (rolling bearing assembly) on one side of the rotor shaft, which can prevent radial movements, axial movements and undesired tilting movements of the rotor shaft, has two rolling element raceways aligned in an O arrangement with respect to one another. The other rolling bearing (additional rolling bearing), on the other side of the rotor shaft, should be arranged such that its rolling element raceway forms an X arrangement with one of the other rolling element raceways of the bearing point arranged on the opposite side of the rotor shaft. Advantageously, the two bearing points of the rotor shaft support the rotor shaft on a stator of the electrical axial flux machine. Advantageously, the two bearing points of the rotor shaft support the rotor shaft on one stator half each of the electrical axial flux machine.

### BRIEF DESCRIPTION OF THE DRAWINGS

Aspects of the disclosure will now be explained in more detail with reference to figures, in which connection various exemplary embodiments are also shown.

In the figures:

FIG. 1 shows a longitudinal sectional view of an electrical machine according to a first exemplary embodiment, wherein a fastening element shown is axially aligned for connecting a stator housing to a main housing body,

FIG. 2 shows a longitudinal sectional view of an electrical machine according to a second exemplary embodiment, wherein the fastening element is radially aligned,

FIG. 3 shows an enlarged region of a longitudinal sectional view of an electrical machine according to a third exemplary embodiment, and

FIG. 4 shows an enlarged region of a longitudinal sectional view of an electrical machine according to a fourth exemplary embodiment.

The figures are only schematic in nature and serve only for understanding the disclosure. The same elements are provided with the same reference symbols. The different features of the various exemplary embodiments can also be freely combined with one another.

### DETAILED DESCRIPTION

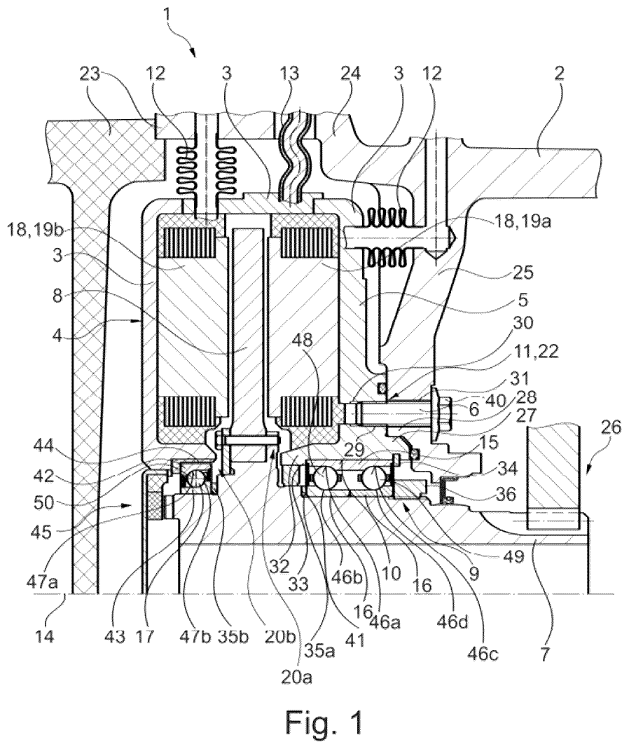

The basic structure of an electrical machine 1 according to the disclosure can be seen particularly well in FIG. 1. In a preferred application, the electrical machine 1 is used in a hybrid or purely electrically driven motor vehicle drive.

The electrical machine 1 has a housing 23 which, in operation, is connected, for example, to a transmission housing of a transmission of the motor vehicle drive. The housing 23 has a main housing body 2. The main housing body 2 has both a radial outer wall 24 and an axial intermediate wall 25 projecting radially inwards from this outer wall 24.

A stator housing 3 is fastened to the intermediate wall 25, as explained in more detail below. The stator housing 3, in turn, accommodates a stator 4, here comprising two coil bodies 18.

A rotor 8 is mounted in a rotatable manner relative to the stator 4, as explained in more detail below. The rotor 8 is fastened to a radially outer side of a connection shaft 7. The connection shaft 7, thus also referred to as the rotor shaft, and the rotor 8 are arranged together coaxially to a central axis of rotation 14. For the sake of completeness, it should be noted that the directional indications “axial/axial direction,” “radial/radial direction,” and “circumferential direction” as used herein relate to this central axis of rotation 14. Consequently, the term “axially” is to be understood as a direction along the axis of rotation 14, the term “radial” is to be understood as a direction perpendicular to the axis of rotation 14 and the term “circumferential direction” is to be understood as a direction along a circular line that runs concentrically around the axis of rotation 14.

With regard to the connection shaft 7, it can further be seen in FIG. 1 that it projects through a central opening in the intermediate wall 25 and is connected outside the housing 23 to further components of the drive train, preferably via a gear connection 26. Those components can be input shafts of a manual transmission or a differential gear.

With regard to the electrical machine 1, it can further be seen that it is designed as an axial flux machine in FIG. 1. The stator 4 and the rotor 8 are thus each essentially designed to be disc-shaped and arranged adjacent to one another in the axial direction. The stator 4 has two disc-shaped stator halves 19a, 19b, each forming a coil body 18. The two stator halves 19a, 19b are designed to be essentially identical in width. Axially between the two coil bodies 18, the disc-shaped rotor 8 is arranged and interacts with the stator halves 19a, 19b in the usual manner during operation for driving the rotor 8. A first stator half 19a is arranged toward a first axial side 20a of the rotor 8 and a second stator half 19b is arranged toward a second axial side 20b of the rotor 8, facing away from the first axial side 20a.

The stator 4, i.e., the stator halves 19a, 19b, are accommodated in a stator housing 3 in a fixed manner. The stator housing 3 surrounds the respective stator half 19a, 19b both radially from the outside and radially from the inside as well as in the axial direction from a side facing away from the rotor 8. In addition, the stator housing 3 is closed toward a radially outer side of the stator halves 19a, 19b/the stator 4.

That part of the stator housing 3 which axially faces the intermediate wall 25 of the main housing body 2 forms a support wall 5. This support wall 5 extends substantially parallel to the intermediate wall 25 and thus in a radial direction from an outer diameter of the stator 4 toward an inner diameter. The support wall 5 directly forms that section of the stator housing 3 which surrounds a first stator half 19a radially from the outside, radially from the inside and toward an axial side facing away from the rotor 8.

The support wall 5 is furthermore fastened to the main housing body 2 on a central support base 22. The support wall 5 and the intermediate wall 25 are in direct contact with one another both in the axial direction with their end faces and in the radial direction via a centering extension 27. In this embodiment, the axially projecting centering extension 27 is formed on the support wall 5 and is pushed into a receptacle 28/receiving shoulder of the main housing body 2. In other words, a direct contact region 11 between the support wall 5 and the main housing body 2 is thus arranged axially offset from the stator 4.

Multiple fastening elements 6 arranged distributed in the circumferential direction are provided for fixing the support wall 5 to the main housing body 2, of which one fastening element 6 is illustrated in FIG. 1. The fastening elements 6 are designed as screws. The respective fastening element 6 projects through a through-hole 31 of the main housing body 2. Each fastening element 6 also has a thread region 29 that is screwed into a female threaded hole 30 in the support wall 5. The fastening element 6 is supported on the main housing body 2 with a head 40.

Radially inside the fastening elements 6, the support wall 5 also forms a bearing journal 32. The bearing journal 32 projects into the stator 4, namely the first stator half 19a, radially from the inside in the axial direction. A rolling bearing assembly 9 is arranged radially from the inside on the connection shaft 32 for radial and axial support of the connection shaft 7 and thus of the rotor 8.

That rolling bearing assembly 9 arranged according to the disclosure thus serves the axial and radial mounting of the connection shaft 7 on a radially inner side 10 of the support wall 5. The rolling bearing assembly 9 is arranged toward the first axial side 20a of the rotor 8 and is radially located inside as well as axially level with the first stator half 19a.

With regard to the rolling bearing assembly 9, it can be seen that its (radial) outer ring 15 is fixed to the bearing journal 32/the support wall 5/the stator housing 3 both in the radial direction as well as axially on both sides. In a first axial direction/toward a first axial side of the outer ring 15, the latter is in contact with a radial shoulder 33 of the bearing journal 32, toward a second axial direction/second axial side of the outer ring 15, it is in contact with a securing ring 34, which is snapped into the bearing journal 32.

A (radial) inner ring 16 of the rolling bearing assembly 9 is fixed to the connection shaft 7 both in the radial direction and axially on both sides. The inner ring 16 is supported in a first axial direction/toward its first axial side, with the interposition of a (first) contact element 35a (in this case a contact disc), on a radial shoulder 41 of the connection shaft 7 and is fixed in a second axial direction/toward its second axial side via a securing element 36 in the form of a shaft nut.

The rolling bearing assembly 9 is further implemented as a double-row rolling bearing. The rolling bearing assembly 9 is designed in particular as a double-row angular contact ball bearing. The outer ring 15 also forms two (a first and a third) rolling element raceways 46a, 46c and is implemented in a materially integral manner. It can further be seen that the inner ring 16 is split in two, wherein a part each of the inner ring 16 forms one of the two (second and fourth) rolling element raceways 46b, 46d of the inner ring 16. A group of first rolling elements 48 of the rolling bearing assembly 9 distributed in an axial plane in the circumferential direction is in contact with the first rolling element raceway 46a and the second rolling element raceway 46b. A group of second rolling elements 49 of the rolling bearing assembly 9 distributed in a different axial plane in the circumferential direction is in contact with the third rolling element raceway 46c and the fourth rolling element raceway 46d. The rolling bearing assembly 9 is implemented (as a double-row angular contact ball bearing) in such a way that its rolling element raceways 46a, 46b, 46c, 46d are positioned relative to one another in an O arrangement (connecting line between contact points of the first rolling elements 48 with the first and second rolling element raceways 46a, 46b forms a radially inwardly open V with the connecting line between contact points of the second rolling element 49 with the third and fourth rolling element raceways 46c, 46d). In further embodiments, however, the rolling bearing assembly 9 can be implemented in other ways, for example as a double-row angular contact roller bearing, preferably as a tapered roller bearing in an O arrangement.

In other words, the rolling bearing assembly 9 is located radially inside the fastening elements 6 and axially at least partially level with the fastening elements 6. At the same time, the rolling bearing assembly 9 is arranged radially inside the stator 4 and in the axial direction at the same level as the stator, in particular the first stator half 19a.

An additional rolling bearing 17 is provided to further support the connection shaft 7/the rotor 8 relative to the stator 4. In this embodiment, the additional rolling bearing 17 is implemented as a (single-row) ball bearing, namely as an angular contact ball bearing, but in further embodiments it can, in turn, also be designed in other ways.

While the rolling bearing assembly 9 is arranged toward the first axial side 20a of the rotor 8, the additional rolling bearing 17 is arranged toward the second axial side 20b of the rotor 8, facing away from the first axial side 20a. The additional rolling bearing 17 is, on the one hand, placed directly on the connection shaft 7 and, on the other hand, supported on the stator housing 3 (radially inside as well as axially level with the second stator half 19b).

In this embodiment, the additional rolling bearing 17 is coupled to the stator housing 3 in such a way that the stator housing 3 can perform a relative radial movement with respect to an outer ring 42 of the additional rolling bearing 17. An additional sleeve 44 inserted between the outer ring 42 and the stator housing 3 is designed in such a way that the outer ring 42/the additional rolling bearing 17 is accommodated via a clearance fit on the housing side/in the stator housing 3 and can thus be displaced radially to a certain extent. At the same time, however, the additional rolling bearing 17 is attached in an axially fixed manner/to transmit axial forces at least on one side between the connection shaft 7 and the stator housing 3. An inner ring 43 of the additional rolling bearing 17 is, in turn, attached to the connection shaft 7 in a radially fixed manner.

The additional rolling bearing 17 is supported by its inner ring 43 axially on one side on the connection shaft 7 with the interposition of a (second) contact element 35b, in this case a contact disc. The outer ring 42 of the additional rolling bearing 17 is supported axially opposite to the support of the inner ring 43 on the stator housing 3 (via the radial collar of the sleeve 44).

The additional rolling bearing 17 arranged on the second stator half 19b/stator housing 3 facing away from the common rigid support base 22 is thus designed as a single-row angular contact ball bearing and has a clearance fit between the outer ring 42 and the bearing seat of the second stator half 19b. The radial clearance of the clearance fit between the additional rolling bearing 17 and the second stator half 19b ensures that the additional rolling bearing 17 can perform a sufficiently large radial displacement to align with the axis of rotation 14 defined by the double-row angular contact ball bearing (rolling bearing assembly 9). Axially, the additional rolling bearing 17 is in contact with the bearing seat of the second stator half 19b, which in this exemplary embodiment is designed as a separate sleeve 44. Through selection of the material or the surface coating of the sleeve 44, the additional rolling bearing 17 can be electrically insulated from the rest of the stator 4 and/or the coefficient of friction resulting at the contact point between the outer ring 42 and the sleeve 44 forming the bearing seat can be influenced in a desired manner. The single-row angular contact ball bearing is in axial contact with both the bearing seat of the second stator half 19b and the bearing seat of the rotor shaft (connection shaft 7) and can therefore transmit axial forces. The double-row angular contact ball bearing is in any case connected in an axially fixed manner to the first stator half 19a/the stator housing 3 and the rotor shaft both on the outer ring 15 and on the inner ring 16 and can thus transmit axial forces even in both directions. It is thus possible for axial forces to be transmitted from one stator half 19a, 19b to the other via the rotor shaft. This allows the bearings and the rotor shaft to help align the two stator halves radially inwards relative to one another with exact axial spacing, thereby precisely adjusting and keeping constant the two air gaps between the rotor and the stator.

Due to its design as a single-row angular contact ball bearing, the additional rolling bearing 17 also has a connecting line set at an angle (i.e., at an angle smaller than 90° and larger than 0° to the axis of rotation 14) between the contact points of its (third) rolling elements 50 with a first rolling element raceway 47a of the outer ring 42 and a second rolling element raceway 47b of the inner ring 43. This connecting line of the additional rolling bearing preferably forms a radially outwardly open V with the connecting line of the rolling bearing assembly 9 extending through the first rolling elements 48, which corresponds to an X arrangement. This bearing assembly thus prevents any magnetic forces that seek to move the stator halves 19a, 19b toward one another from having to be supported radially outwardly around the rotor 8 via the mechanical structure of the stator 4. The two stator halves 19a, 19b can thus transmit axial forces in opposite directions to the connection shaft 7 (rotor shaft) via the rolling elements 48, 50 in the X arrangement and thus support one another radially on the inside via the connection shaft 7. Of the magnetic forces acting axially on the stator halves 19a, 19b and seeking to move the stator halves 19a, 19b toward each other, one part is then supported radially outwardly around the rotor 8 via the mechanical structure of the stator 4 and the other part is supported via the connection shaft 7. The X arrangement on either side of the rotor 8 and the rotor shaft thus reduces the mechanical stress on the stator structure, allowing for a smaller, lighter and less expensive motor design.

It can further be seen that the stator housing 3 is arranged outside the common central support base 22, axially and radially spaced apart from the main housing body 2 and the overall housing 23. Only individual connection structures 12, 13 in the form of fluidic connection structures 12 and electrical connection structures 13 are present that indirectly couple the stator housing 3 and the housing 23 together.

In the first embodiment, two fluidic connection structures 12 and one electrical connection structure 13 are present. The fluidic connection structures 12, 13 serve primarily to introduce and discharge fluids, in particular cooling fluids; the electrical connection structures 13 primarily serve to transmit electrical power. The connection structures 12, 13 are necessarily attached to the main housing body 2 on the one hand and attached to the stator housing 3/the stator 4 on the other hand.

The connection structures 12, 13 are designed in a targeted manner to be softer than the support base 22. For this purpose, the electrical connection structure 13 in this embodiment is designed as a cable routed in a curved manner, though this can also be implemented in other ways in further embodiments. The two fluidic connection structures 12 are designed as corrugated tubes by way of example. Thus, both the fluidic connection structures 12 and the electrical connection structures 13 are resilient as well as bendable in the axial direction and the radial direction.

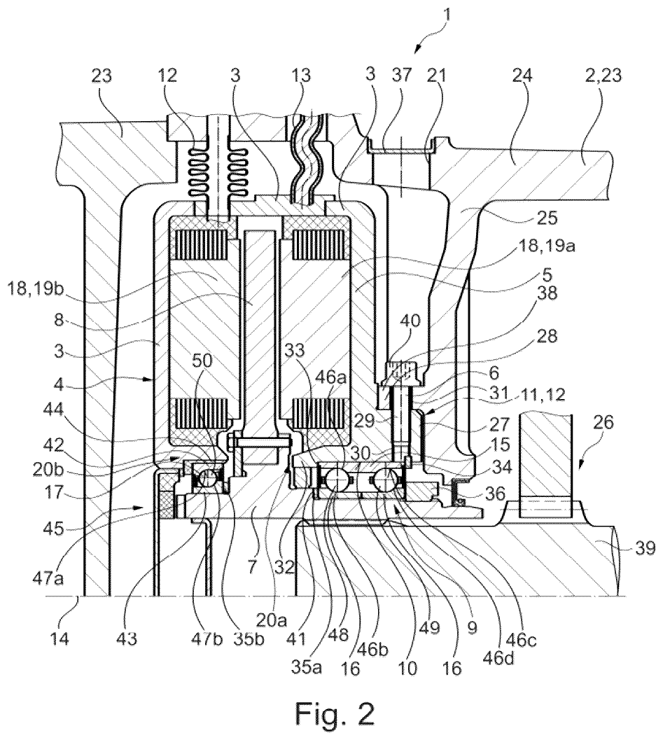

In connection with FIG. 2, a second exemplary embodiment of the electrical machine 1 according to the disclosure is illustrated, which corresponds to the first exemplary embodiment with regard to its basic structure. For the sake of brevity, therefore, only the differences between these two exemplary embodiments are described below.

It can be seen in FIG. 2 that the fastening element 6 is not aligned parallel but perpendicular to the central axis of rotation 14. The fastening element 6 is accessible radially from the outside via an axial gap between the support wall 5 and the intermediate wall 25 radially outside the support base 22. For this purpose, a through-opening 21 is also made in the radial outer wall 24 of the main housing body 2 for each fastening element 6, wherein the through-opening 21 is provided in alignment with the fastening element 6. After installation, the through-opening 21 is closed with a cover 37.

Due to the radial alignment of the fastening elements 6, the intermediate wall 25 is also aligned on the side of the support base 22. The intermediate wall 25 has an axial projection 38 through which the fastening element 6 passes radially. That projection 38 rests on the centering extension 27 of the support wall 5 radially from the outside.

It is further considered self-explanatory that the fastening element 6 is screwed with its thread region 29 into a radially extending female threaded hole 30 of the centering extension 27. It can be seen that the female threaded hole 30 is (at least in sections) arranged axially level with the rolling bearing assembly 9. As a result, the fastening element 6 is in turn also level with the rolling bearing assembly 9 in the axial direction.

Furthermore, it can be seen that the connection shaft 7 in the second exemplary embodiment no longer projects directly out of the housing 23, but forms a shaft section which is connected radially within the rolling bearing assembly 9 (via a serration) to a further output shaft 39, wherein this output shaft 39 then projects out of the housing 23.

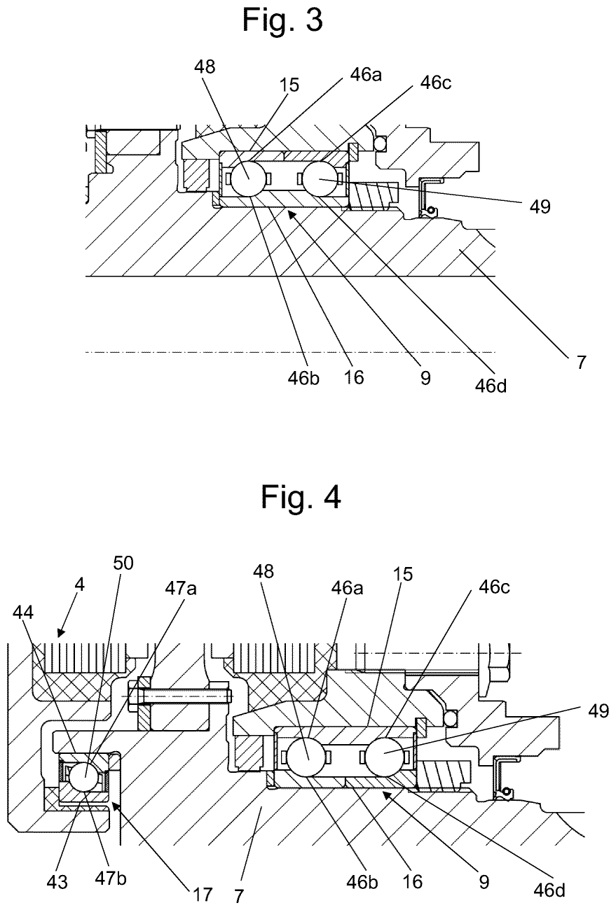

FIG. 3 shows an enlarged region of a longitudinal sectional view of an electrical machine according to a third exemplary embodiment.

More specifically, FIG. 3 shows an enlarged region showing the rolling bearing assembly 9 of FIG. 1 in a different embodiment than that shown in FIG. 1.

With the exception of this differing embodiment of the rolling bearing assembly 9, the third exemplary embodiment is identical to the first exemplary embodiment shown in FIG. 1, so that the explanations given previously with respect to the first exemplary embodiment apply equally to the third exemplary embodiment.

Likewise, the other embodiment of the rolling element assembly 9 can be applied to the second exemplary embodiment shown in FIG. 2 so that the explanations given previously with respect to the second exemplary embodiment apply equally to the third exemplary embodiment.

If the connection shaft 7 is rigidly connected to another rotatably mounted component (for example, the output shaft 39 or a transmission input shaft) to the extent that the rolling bearing assembly 9 need not stabilize the axis of rotation of the rotor 8 by itself, the rolling element raceways 46a, 46b, 46c, 46d of the rolling element assembly 9 can be arranged such that the two rolling elements 48, 49 of the rolling element assembly 9 are positioned in an X arrangement. Since the X arrangement stabilizes the shaft to a lesser extent, the X arrangement reduces the risk that a concentricity mismatch between the rolling bearing assembly 9 and the mounting of the component rigidly connected to the connection shaft 7 will cause undesired distortion of the bearings, thus reducing bearing life.

In the case of a rolling bearing assembly 9 in an X arrangement, the rolling bearing assembly 9 is further implemented as a double-row rolling bearing or as two single-row rolling bearings arranged adjacent to one another. The rolling bearing assembly 9 is designed in particular as a double-row angular contact ball bearing. The outer ring 15 then forms two rolling element raceways 46a, 46c, just as previously described for the double-row angular contact ball bearing in an O arrangement in FIG. 1 or FIG. 2, and the inner ring 16 also forms two rolling element raceways 46b, 46d. The arrangement of these rolling element raceways 46a, 46b, 46c, 46d differs from that of the O arrangement. If one mentally passes axially through the double-row rolling bearing assembly 9 in an X arrangement from left to right in FIG. 3, there is first a rolling element raceway 46a on the outer ring 15 axially in front of and radially outside the first rolling elements 48 distributed on the circumference. This is followed on the other side of these first rolling elements 48 by a rolling element raceway 46b on the inner ring axially behind and radially inside the first rolling elements 48. If one then mentally continues axially from left to right in FIG. 3 in the same direction through the double-row rolling bearing assembly 9 in an X arrangement, there is a rolling bearing raceway 46d on the inner ring axially in front of and radially inside the second rolling elements 49 distributed on the circumference. Then, on the other side of the second rolling elements 49, a rolling element raceway 46c follows on the outer ring axially behind and radially outside the second rolling elements 49.

The rolling bearing assembly 9 in an X arrangement is implemented (as a double-row angular contact ball bearing) in such a way that its rolling element raceways 46a, 46b, 46c, 46d are positioned relative to one another in an X arrangement, i.e., a connecting line between contact points of the first rolling elements 48 with the rolling element raceway 46a on the outer ring 15 and the rolling element raceway 46b on the inner ring 16 forms a radially outwardly open V with a connecting line between contact points of the second rolling elements 49 with the rolling element raceway 46d on the inner ring 16 and the rolling element raceway 46c on the outer ring 15. In the rolling bearing assembly 9, the inner ring 15 and/or the outer ring 16 can be of a multi-part design. In the case of the rolling bearing assembly 9 in an X arrangement, the outer ring 15 in particular can be of a two-part design, so that the outer ring 15 is formed from two rings, each of which forms a rolling bearing raceway.

The possibility described above of the two stator halves supporting one another radially on the inside in the axial direction via the additional rolling bearing 17, the connection shaft 7 (rotor shaft) and the rolling bearing assembly 9 and thus being able to better bear the magnetic forces acting on them also exists if the rolling bearing assembly 9 is designed in an X arrangement.

Due to its design as a single-row angular contact ball bearing, the additional rolling bearing 17, see FIG. 1 and FIG. 2, has a connecting line set at an angle, i.e., at an angle smaller than 90° and larger than 0° to the axis of rotation 14, between the contact points of its (third) rolling elements 50 with a first rolling element raceway 47a of the outer ring 42 and a second rolling element raceway 47b of the inner ring 43. This connecting line of the additional rolling bearing 17 forms, if the rolling bearing assembly 9 is designed in an X arrangement as shown in FIG. 3, a radially outwardly open V with the connecting line of the rolling bearing assembly 9 extending through the second rolling elements 49, which also corresponds to an X arrangement. This bearing assembly consisting of the additional bearing 17 and the rolling bearing assembly 9 in an X arrangement can thereby prevent, just as the previously described bearing assembly consisting of the additional bearing 17 and the rolling bearing assembly 9 in an O arrangement, any magnetic forces that seek to move the stator halves 19a, 19b toward one another from having to be supported radially outwardly around the rotor 8 via the mechanical structure of the stator 4. The two stator halves 19a, 19b can thus transmit axial forces in opposite directions in each case to the connection shaft 7 (rotor shaft) via the rolling elements 49, 50 in the X arrangement and thus support one another radially on the inside via the connection shaft. Of the magnetic forces acting axially on the stator halves 19a, 19b and seeking to move the stator halves 19a, 19b toward each other, one part is then supported radially outwardly around the rotor 8 via the mechanical structure of the stator 4 and the other part is supported via the connection shaft 7. The X arrangement on either side of the rotor 8 and the connection shaft (rotor shaft) 7 thus reduce the mechanical stress on the (radially outer) stator structure, allowing for a smaller, lighter and less expensive motor design.

FIG. 4 shows an enlarged region of a longitudinal sectional view of an electrical machine according to a fourth exemplary embodiment.

More specifically, FIG. 4 shows an enlarged region showing the additional rolling bearing 17 of FIG. 1 in a different embodiment than that shown in FIG. 1.

With the exception of this differing embodiment of the additional rolling bearing 17, the fourth exemplary embodiment is identical to the first exemplary embodiment shown in FIG. 1, so that the explanations given previously with respect to the first exemplary embodiment apply equally to the fourth exemplary embodiment.

Likewise, the other embodiment of the additional rolling bearing 17 can be applied to the second exemplary embodiment shown in FIG. 2 and the third exemplary embodiment shown in FIG. 3, so that the explanations given previously with respect to the second exemplary embodiment and the third exemplary embodiment apply equally to the fourth exemplary embodiment.

In this variant of the additional rolling bearing 17, in which the outer ring 44 is connected to the connection shaft 7 (rotor shaft) and the inner ring 43 is connected to the stator 4, the possibility of the two stator halves supporting one another radially on the inside in the axial direction via the additional rolling bearing 17, the connection shaft 7 (rotor shaft) and the rolling bearing assembly 9 and thus being able to better bear the magnetic forces acting on them also exists. The additional rolling bearing 17 is designed in particular as a single-row angular contact ball bearing. In order for the stator half, which is in contact with the inner ring 43 of the additional rolling bearing 17 in a manner capable of transmitting at least axial forces, to be able to support itself on the connection shaft 7 (rotor shaft), the inner ring 43 has a rolling bearing raceway 47b which, viewed in the force direction (force transmission from the stator half to the shaft), is located in front of and radially inside the rolling elements 50 of the additional rolling bearing 17. The outer ring 44 is connected to the connection shaft 7 (rotor shaft) and, also viewed in the force direction, has a rolling bearing raceway 47a axially behind and radially outside the rolling elements 50 of the additional rolling bearing 17. The connecting line between the contact points of the rolling elements 50 of the additional bearing 17 with the rolling element raceway 47a on the outer ring 44 and the rolling element raceway 47b on the inner ring 43 is oriented the other way around in this embodiment variant compared to the previously described exemplary embodiments. Since the assignment of the inner and outer rings 43, 44 to the stator (stator half) and the rotor (connection shaft 7) is interchanged, the alignment of the rolling bearing raceways 47a, 47b must also be interchanged, which changes the alignment of the connecting line between the contact points of the rolling elements 50 with the rolling element raceway 47a on the outer ring 44 and the rolling element raceway 47b on the inner ring 43 in order to be able to maintain the axial force transmission direction between the stator half and the additional shaft in an unchanged manner. In the exemplary embodiment described here, the additional rolling bearing 17 thus forms an O arrangement with one of the two rolling elements (48 or 49) of the rolling bearing assembly 9. (The connecting line between the contact points of the rolling elements 50 of the additional rolling bearing 17 with the rolling element raceway 47a on the outer ring 44 and the rolling element raceway 47b on the bearing inner ring 43 forms a radially inwardly open V with the connecting line between the contact points of the rolling elements 48 or 49 of the rolling bearing assembly 9 with their rolling element raceways 46b, 46d on the inner ring 16 and their rolling element raceways 46, 46c on the outer ring 15). Via these rolling elements 48, 49, 50 oriented in an O arrangement on both sides of the rotor, axial force transmission is possible between the two stator halves via the additional rolling bearing 17, the connection shaft 7 (rotor shaft) and the rolling bearing assembly 9. The two stator halves can thus support one another radially on the inside of the motor in the axial direction and thus better bear the magnetic forces acting on them. In this variant, too, the inner ring 43 and the outer ring 44 of the additional rolling bearing 17 can each be connected in an axially and radially fixed manner to their adjacent components or connected only in an axially fixed and radially displaceable manner to their adjacent components. In this variant, it is possible in particular for the outer ring 44 to be connected in a radially and axially fixed manner to the connection shaft 7 and for the inner ring 43 to be connected in an axially fixed manner (so that forces can be transmitted in at least an axial direction) to the stator (stator half) and for the inner ring 43 to be able to radially perform relative movements to the stator.

Expressed in other words in relation to the previous explanations, in the practical design of electric motors for motor vehicles, the need to make the structure of the electric motor particularly rigid often conflicts with the requirements for compact design, low weight, high power density and low costs that always exist in vehicle construction.

Instead of designing all load-bearing components to be particularly rigid, robust and large, it usually makes more sense to take additional measures or provide additional components at suitable points to ensure that the load on the neighboring parts is reduced. This description therefore presents an arrangement and fastening principle for an electric motor in which forces and displacements acting on the electric motor from outside always lead to displacements of the stator and the rotor of the same magnitude and in the same direction. As a result, the position of the rotor relative to the stator remains the same even if the electric motor as a whole is displaced. This is made possible by a common rigid support base on which the stator, the rotor and the output element connected to the rotor are supported or mounted. In this case, the stator and rotor are rigidly connected only to the common support base, or are connected to the common support base and also to the elements rigidly connected to the support base. By not rigidly connecting the stator and rotor to surrounding components that experience other displacements or deformations than the common rigid support base, the stator and rotor are also not subjected to external constraining forces or forced deformations that could deform the structure of the stator or rotor to an unacceptable extent, resulting, for example, in an unacceptably large change in the air gap.

In order for the common support base to improve the mounting of the rotor relative to the stator, the common support base must not allow any relevant deformations between its connection point for the rotor and its connection point for the stator. To ensure that the common support base is sufficiently rigid without the use of extreme amounts of material, which would be too expensive and too heavy for vehicle construction, it makes sense to arrange the fastening points provided by the common support base for the components or assemblies fastened to it as close together as possible. For electric motors, in particular for axial flux motors, it is therefore considered expedient to arrange the common rigid support base laterally adjacent (/axially adjacent) and/or radially below the active parts of the motor on the smallest possible diameter around a component that connects the rotor to the unit drivable by the motor for the purpose of torque transmission (e.g., a shaft). The active parts are the motor components through which the magnetic fields pass, which cause the torque between the stator and rotor.

The common rigid support base expediently consists of two structural units (components or assemblies) rotationally decoupled by at least one bearing. One of the structural units is connected to the stator of the electric motor (rotationally stationary structural unit of the common rigid support base) and the other of the two structural units is connected to the rotor of the electric motor (rotatable structural unit of the common rigid support base). The two structural units are fastened together by the at least one bearing. The at least one bearing allows the two structural units to rotate relative to one another about an axis of rotation. Translational movements of the two structural units of the common rigid support base relative to one another are prevented or limited to a very small extent by the at least one bearing. This applies in particular to radial or axial displacements of the two structural units relative to one another. Also, tilting or rotational movements of the two structural units that do not occur about the axis of rotation of the bearing are prevented or limited to a very small extent by the at least one bearing. The structural unit of the common rigid support base connected to the stator can be formed, for example, by the stator and the electric motor housing (stator housing/support wall) or by one or more components connected to the stator and/or the electric motor housing. A bearing connecting the two structural units of the common rigid support base can be fastened to both the component associated with the stator and/or the component associated with the housing. If multiple bearings are arranged between the two structural units of the common rigid support base, they can all be fastened to the component associated with the stator or the component associated with the housing. There can also be at least one bearing fastened to the component associated with the stator and at least one bearing fastened to the component associated with the housing.

The other structural unit of the common rigid support base connected to the rotor can consist, for example, of the rotor (e.g., the rotor shaft/connection shaft) or a component connected thereto and a torque transmission element connecting the rotor to the unit drivable by the motor for the purpose of torque transmission (e.g., a shaft) or a component connected thereto. A bearing connecting the two structural units of the common rigid support base can be fastened to both the component associated with the rotor and/or the component associated with the torque transmission element. If multiple bearings are arranged between the two structural units of the common rigid support base, they can all be fastened to the component associated with the rotor or the component associated with the torque transmission element. There can also be at least one bearing fastened to the component associated with the rotor and at least one bearing fastened to the component associated with the torque transmission element.

Important Aspects are (Rotor Mounting):

The rotor shaft is mounted on one side of the rotor with a double-row bearing (e.g., a double-row angular contact ball bearing) or two neighboring bearings. This bearing point can prevent radial movements, axial movements and undesired tilting movements of the rotor shaft or limit them to a very small extent. On the other side of the rotor shaft, the rotor shaft is supported by a further bearing which can transmit at least axial forces (e.g., a single-row angular contact ball bearing, possibly with a radial clearance fit on the inner or outer ring).

If the rotor shaft is mounted by means of angular contact ball bearings, tapered roller bearings or other bearings with a force transmission direction oblique to the axis of rotation of the bearings (for example, caused by the contact angle or pressure angle of the rolling elements in rolling contact with the bearing raceways), it is expedient that the bearing point on one side of the rotor shaft, which can prevent radial movements, axial movements and undesired tilting movements of the rotor shaft, has two rolling element raceways aligned in an O arrangement with respect to one another. The other rolling bearing, on the other side of the rotor shaft, should be arranged such that its rolling element raceway forms an X arrangement with one of the other rolling element raceways of the bearing point arranged on the opposite side of the rotor shaft.

The two bearing points of the rotor shaft connect the rotor shaft with the stator of an axial flux motor.

The two bearing points of the rotor shaft connect the rotor shaft to one stator half each of an axial flux motor.

Via the two bearing points, an axial force can be transmitted from one stator half to the other stator half via the rotor shaft. Depending on the bearing design, this can prevent or at least limit the stator halves from moving toward or away from one another. If both bearing points can transmit axial forces in both axial directions, forces can also be transmitted in alternating axial directions between the stator halves.

In an axial flux motor, where the magnetic forces seek to move the two stator halves toward one another, these forces can be at least partially axially supported by the two bearings and the rotor shaft.

An electric motor arrangement, in particular for an electric axle of a motor vehicle, is described:

FIG. 1 shows an electric motor arrangement that is useful for electric axles of motor vehicles. In this exemplary embodiment, the electric motor is designed as an axial flux motor. The motor consists of a rotor and a stator.

The stator consists of two stator halves connected to one another radially on the outside, each of which is connected to the rotor shaft radially on the inside via a bearing point in a rotationally decoupled manner. The rotor is fastened to the rotor shaft and consists of a disc-shaped section extending radially outwards between the two stator halves. The air gaps through which the axial magnetic flux of the motor passes are located between the two stator halves and the rotor. The magnetic spring of the motor causes a torque that acts on the rotor and is introduced into the rotor shaft by the rotor. The rotor shaft projects out of the motor in the axial direction and has a toothing at its end through which the torque of the motor can be transmitted to a neighboring unit. This neighboring unit can be, for example, a transmission (indicated in FIG. 1 by a spur gear stage), a differential, a shaft or a wheel of the motor vehicle.

The stator half facing the transmission is connected radially on the inside to the housing surrounding the electric motor. For this purpose, the housing has a side wall or intermediate wall which is screwed to this stator half. It makes sense in this regard to arrange multiple screws distributed around the circumference. Radially inside this screw connection point, a bearing (designed as a double-row angular contact ball bearing in an O arrangement in this exemplary embodiment) is arranged which connects the stator half to the rotor shaft in a rotationally decoupled manner. By means of this bearing, which connects the rotor shaft axially and radially to the one stator half and also prevents the rotor shaft from tilting about an axis that deviates from the axis of rotation of the motor, the rotor and stator are already mounted sufficiently relative to one another to form a functional unit. The region shown in FIG. 1, which comprises the bearing and the screw connection, provides a common rigid support base for all important major components.

Bearing:

In the exemplary embodiment, a further bearing is optionally arranged on the motor side facing away from the common rigid support base, which connects the further stator half to the rotor shaft. This bearing can be designed or installed in such a way that it can transmit radial and axial forces or be designed as an axially displaceable bearing (bearing transmits mainly radial forces) or as a radially displaceable bearing (bearing transmits mainly axial forces). If the bearing transmits radial forces, the rotor shaft can be supported on either side of the rotor on one stator half each. This makes it possible to achieve a very rigid mounting of the rotor shaft, but the two bearing points must be concentrically aligned in a very precise manner to prevent distortion of the two bearings. If it is not possible to ensure a sufficiently precise alignment of the bearings to prevent distortion of the bearings and the associated bearing overload, it is advisable to install the bearing arranged on the motor side facing away from the common rigid support base in a radially displaceable manner or to select a bearing type that permits radial compensation between the two bearing sides anyway. The axis of rotation of the rotor shaft is then determined only by the double-row angular contact ball bearing on the other stator half. In the exemplary embodiment shown in FIG. 1, the bearing arranged on the stator half facing away from the common rigid support base is designed as a single-row angular contact ball bearing that has a clearance fit between the outer ring and the bearing seat of the stator half. The radial clearance fit between the bearing and the stator half ensures that the bearing can perform a sufficiently large radial displacement to align with the axis of rotation defined by the double-row angular contact ball bearing. Axially, the bearing is in contact with the bearing seat of the stator half, which in this exemplary embodiment is designed as a separate sleeve. Through selection of the material or the surface coating of the sleeve, the bearing can be electrically insulated from the rest of the stator and/or the coefficient of friction resulting at the contact point between the bearing outer ring and the sleeve forming the bearing seat can be influenced in a desired manner. (With a high coefficient of friction, radial rotor shaft vibrations can be damped particularly effectively, and with a low coefficient of friction, the rotor shaft aligns itself particularly quickly and particularly accurately with the axis of rotation specified by the double-row angular contact ball bearings.) The single-row angular contact ball bearing is in axial contact with both the bearing seat of the stator half and the bearing seat of the rotor shaft and can therefore transmit axial forces. The double-row angular contact ball bearing is in any case connected in an axially fixed manner to the stator half and the rotor shaft on both the outer ring and the inner ring and can therefore transmit axial forces even in both directions. It is thus possible for axial forces to be transmitted from one stator half to the other via the rotor shaft. This allows the bearings and the rotor shaft to help align the two stator halves radially inwards relative to one another with exact axial spacing, thereby precisely adjusting and keeping constant the two air gaps between the rotor and the stator. In the exemplary embodiment shown in FIG. 1, the single-row angular contact ball bearing together with a ball raceway (rolling element raceway) of the double-row angular contact ball bearing (in FIG. 1, this is the ball raceway directly adjacent to the rotor) located on the other side of the rotor form an X arrangement by means of which the two stator halves, which seek to move toward one another due to the magnetic forces, can be supported axially on one another. This bearing assembly thus prevents any magnetic forces that seek to move the stator halves toward one another from having to be supported radially outwardly around the rotor via the mechanical structure of the stator. The X arrangement of the bearing raceways (rolling element raceways) on either side of the rotor and the rotor shaft thus reduce the mechanical stress on the stator structure, allowing for a smaller, lighter and less expensive motor design.

Common Rigid Support Base:

The exact alignment of all parts through which the magnetic fields of the motor flow is very important for the functioning of the electric motor. Even minor positional deviations between the parts have a major influence on the performance and efficiency of the motor. Unintentional changes in the air gap widths between the rotor and stator have a particularly large negative influence on the characteristics of the electric motor. An electric motor must therefore be designed and connected to its neighboring units in such a way that forces occurring inside the electric motor and forces acting on the electric motor from outside do not lead to an impermissibly high change in the air gap widths. In order to be able to support the internal forces of the electric motor effectively and at low cost, this description presents a special bearing assembly between the two stator halves and the rotor shaft. In order to make the electric motor insensitive to forces and displacements acting on the electric motor from outside, a central common rigid support base is presented in this description. Forces and displacements acting on the electric motor from outside can be caused, for example, by elastic deformations of the electric axle housing or electric motor housing occurring during driving operation of the motor vehicle. A further cause of axial forces acting on the electric motor from outside is often due to helical gearing in the units adjacent to the electric motor. For example, if the electric motor is connected to a transmission as indicated in FIGS. 1 and 2. When the torque changes, so do the axial reaction forces that the helical gears exert on their bearings, shafts and housing. Since the support elements of the transmission (especially the support walls or side walls/the main housing body and the intermediate wall) are never absolutely rigid and always have a certain elasticity, a change in the torque transmitted in the drive train between the electric motor and the wheel of the motor vehicle due to the helical gears almost inevitably leads to an undesired elastic displacement of components of the drive train such as the connection shaft between the electric motor and the transmission or the support wall or side wall of the housing (intermediate wall of the main housing body).

The main risks posed to the motor by these displacements are, on the one hand, that fatigue strength problems could arise in the electric motor structure due to constantly changing forces and deformations acting on the motor from outside, or that the structure would have to be designed from the outset for a high mechanical load-bearing capacity, to the detriment of power density and efficiency optimization. On the other hand, deformation of the rotor and/or stator can change the shape of the magnetically relevant air gap between the two components and thus worsen the performance and efficiency of the motor. It also severely limits the electrically and magnetically optimal design of the motor if a large minimum gap width must be provided so that the two components never come into contact during operation, since constant air gap changes must be expected during operation.

If the rotor and the stator of the electric motor are fastened to components or are in operative connection with components that perform different displacements or the components to which the stator or the rotor is fastened or with which there is an operative connection exert forces on the electric motor, the structure of the electric motor can be subjected to impermissibly high loads and/or the air gap widths can be changed in an impermissible manner. In order for displacements of the electric motor housing in the region where the electric motor is fastened to the housing and/or displacements of the shaft (or of a differently designed torque-transmitting connection element) between the electric motor and transmission (or of a differently designed unit receiving the torque of the electric motor) to not lead to a relative displacement between the active parts of the rotor and the stator (the active parts of the motor are all components which serve to generate the necessary magnetic fields or through which they flow) or for forces acting on the motor from outside to not place a load on structural elements of the motor which are not designed for this, the electric motors presented in the exemplary embodiments here all have a central common rigid support base to which both the stator and the rotor of the electric motor are fastened and onto which the components adjacent to the motor exert the noteworthy forces on the motor (e.g., housing and connection shaft or output shaft). In FIGS. 1 and 2, the region of the central common rigid support base is clearly visible. In FIG. 1, the central common rigid support base consists of two structural units rotatable relative to one another about the rotor axis of the electric motor rotor by the double-row angular contact ball bearing, but otherwise rigidly connected to one another. The one structural unit consists of the radially inner part of the stator half, which is screwed to the radially inner part of the housing support wall, which also forms part of the structural unit. The other structural unit of the central common rigid support base consists of the rotor shaft, which also forms the output shaft of the electric motor by transitioning into the transmission input shaft in an integral manner. Since all components of the motor are supported on the central common rigid support base and otherwise only support one another or are connected to other adjacent components via highly elastic connection elements, all forces and displacements acting on the electric motor from the outside act on the central common rigid support base. The common rigid support base can thus transmit forces acting on the motor from outside via the transmission input shaft (or a differently designed torque-transmitting connection element) to the support wall of the housing, without structural elements of the electric motor that are not part of the central common rigid support base being loaded by these forces in an impermissible manner. Through the central common rigid support base, the support wall of the housing (or a differently designed fastening contour of the element carrying the electric motor) and the transmission input shaft (or a differently designed torque-transmitting connection element) are also connected in such a way that their spatial displacements are coupled to one another. The support wall of the housing (or a differently designed fastening contour of the element carrying the electric motor) and the transmission input shaft (or a differently designed torque-transmitting connection element) can therefore only perform the same displacements (simultaneously the same direction of movement and the same displacement distance). The central common rigid support base thus always performs the same displacement as the adjacent components connected to the electric motor in a fixed manner, taking the rotor and the stator with it in the same way. This allows the rotor and stator to perform only the same displacement, such that there is no significant relative displacement between the rotor and stator that would change the air gap widths. Thus, axial displacement of the transmission input shaft, which is particularly problematic for conventionally mounted axial flux motors because it can displace the rotor axially relative to the stator and thus directly affect the air gap widths, results in this axial flux motor with a central common rigid support base in the central common rigid support base displacing axially and thus the rotor and stator are displaced together, which has no effect on the air gap width.

In order for the functional principle of the central common rigid support base to work well, the common support base should be sufficiently rigid so that it can transmit forces without the connection contours or connection elements that the support base provides for the components or assemblies fastened to it deforming to a relevant extent or deforming relative to one another. It is therefore considered expedient to design all components or component regions forming the central common rigid support base as rigidly as possible and to arrange them compactly in the immediate vicinity. The closer together the connection contours or connection elements that the support base provides for the components or assemblies fastened to it can be arranged, the smaller the deformations that occur between them. In the exemplary embodiments, the common support base is therefore arranged laterally next to the active parts of the electric motor around the transmission input shaft in order to bring together in the smallest possible space all the important components that the common support base must connect to one another. This also results in a closely adjacent arrangement of the rigid bearing between the two structural units of the common support base and the connection (screw connection) between the stator and housing located radially far inside. The arrangement of the connection point between the stator and housing radially close above the bearing between the stator and the rotor shaft or between the housing and the rotor shaft is particularly technically expedient. In exemplary embodiment 1, this screw connection between the housing and the stator is provided axially through the side wall or support wall of the housing. To prevent oil from entering the electric motor through this screw connection, an O-ring is arranged radially inside and radially outside the screw connection region between the stator and housing. Alternatively, seals can be placed under the screw heads or on the screw shafts to prevent oil from flowing through holes in the side wall or support wall necessary for the screw connection. In addition, the threaded holes in the stator are sealed.

In order for the functional principle of the central common rigid support base to work well, the rotor and stator should be able to follow the displacement that the central common rigid support base transmits to the rotor and stator without hindrance. Any additional connections between the rotor and a neighboring unit of the electric motor as well as the stator and a neighboring unit of the electric motor that are not provided via the central common rigid support base should therefore be much softer than the central common rigid support base and the structural elements of the rotor and stator between the central common rigid support base and the additional connection point with a neighboring unit of the electric motor, so that the displacements which occur relatively between the central common rigid support base and the additional connection point only lead to deformations at the connection elements used at the additional connection point and not to deformations of the rotor or the stator. In the figures, therefore, the indicated connection elements for the cooling fluid and the electric current are shown as flexible connection elements (corrugated tube and cable routed in a curved manner). Alternatively, hoses or pipe sections that can be tilted on both sides and are designed to be axially displaceable can be used, for example, to transfer the cooling fluid between the stator and the unit providing the cooling fluid. Alternatively, elastic busbars or electrical conductors consisting of many thin wires can be used to transmit the electrical current.

In FIG. 1, a rotor position sensor 45 is fastened to the left of the single-row angular contact ball bearing on the stator half there, which detects the angular position of the rotor shaft. This allows the angular position of the magnets installed in the rotor relative to the magnets of the stator to be determined. This information is used for controlling the motor.

A shaft grounding element is arranged between the rotor and the double-row angular contact ball bearing in FIG. 1. This can prevent any significant electrical voltage from building up between the bearing outer ring and the bearing inner ring, which could cause damage to the bearing.

FIG. 2 shows a further exemplary embodiment in which the connection point between the housing wall (intermediate wall) and the stator is implemented by means of a radial screw connection. In this exemplary embodiment, in which a transmission adjoins the housing wall designed as a support wall for the electric motor, this radial screw connection allows the electric motor to be installed or removed without having to use tools to reach into the housing region of the transmission. (In the exemplary embodiment of FIG. 1, this is necessary because the screws arranged axially there project through the support wall of the housing and must be installed or removed from the transmission side.) To install the electric motor shown in FIG. 2, it is inserted axially into the motor housing and pushed onto the centering seat of the support wall until the axially acting stop surface of the stator rests against the corresponding stop surface of the support wall. The circumferential orientation of the stator is aligned such that the radial threaded holes in the stator correspond to the radial through-holes in the fastening contour of the support wall and, in addition, the electrical connections and the cooling fluid connections are in the correct position. The fastening screws are then inserted radially from the outside into the motor housing through openings in the motor housing that can later be closed with covers, and screwed into the threaded holes. In the exemplary embodiment, the screws are equipped with a particularly high head so that the screws can be easily held with a tool and safely installed and removed (without falling into the motor housing). At the cylindrical centering seat between the support wall and the stator, the radial assembly clearance should be limited by an accurate and tight fit to the extent absolutely necessary for installation in order to avoid undesired distortion of the two components to be screwed together. If the installation process allows it, a slight interference is also useful (e.g., a transition or press fit).

In the exemplary embodiment shown in FIG. 2, the rotor shaft is connected to the transmission input shaft by a spline (alternatively, it can also be a differently designed torque-transmitting connection element for a unit of the drive train that receives the torque of the motor). This transmission input shaft can be supported by the rotor shaft on the common rigid support base in the radial direction. The spline between the rotor shaft and the transmission input shaft can be assumed to be quasi-rigid as soon as high torques are transmitted in the spline, since the contact forces acting on the tooth flanks are then very high. In order to be able to displace the transmission input shaft axially relative to the rotor shaft, a very high axial frictional force would then have to be overcome. Thus, also in the exemplary embodiment of FIG. 2, the transmission input shaft can transmit undesired forces and displacements to the rotor. The central common rigid support base also ensures in this exemplary embodiment that these forces and displacements do not negatively affect the air gaps between the rotor and stator. The connection point between the rotor shaft and the transmission input shaft is functionally part of the central common rigid support base in the exemplary embodiment of FIG. 2.

In the exemplary embodiment of FIG. 2, the electric motor is protected from the transmission oil by a radial shaft seal between the support wall and the rotor shaft and by a cover closing the axial inner through-opening in the rotor shaft. This sealing concept can also be applied to the exemplary embodiment of FIG. 1.

Notes:

The connection point between the support wall and the rotor of the electric motor has been arranged at the smallest possible diameter in the exemplary embodiments in order to show how the most rigid support base possible can be created in which only minimal and negligible elastic deformations occur between the components or component regions connected to the support base. If it is not structurally possible to pull the support wall of the motor housing (intermediate wall of the main housing body) so far radially inwards (for example, because the space required for this is not available or the support wall would become too soft as a result), it is also possible to move the connection point between the stator and the housing (screw connection) further radially outwards. This increases the distance between the connection point between the stator and the housing (screw connection) and the bearing between the two structural units of the support base. This makes the support base somewhat more elastic, but can certainly be a technically sensible compromise in the overall context of a real electric motor connection. In extreme cases, the connection point between the stator and the housing (screw connection) can be moved radially outwards close to the stator outer diameter.

The single-row and double-row angular contact ball bearings shown in the exemplary embodiments are always shown only as examples of bearings with these characteristics. In all exemplary embodiments, bearings of a different design can always be used which can transmit the radial forces, axial forces and/or tilting moments to be transmitted at this bearing point. In order to provide the bearing rigidity required for the common rigid support base, the double-row angular contact ball bearing can also be replaced by two tapered roller bearings in an O arrangement, which are even more rigid due to their design.

The common rigid support base and bearing assembly for the rotor shaft presented here are particularly useful for axial flux motors, as these electric motors are particularly sensitive to forces acting axially on them due to their slim disc-shaped design. However, the common rigid support base and bearing assembly for the rotor shaft are also expedient for all other electric motors in order to reduce the axial force load on the structure of the electric motor.

In the context of this application, the term “drive train” is understood to mean all components of a motor vehicle that generate the power for driving the motor vehicle and transmit it to the road via the vehicle wheels.

Although the present disclosure has been described above in terms of embodiments, it is to be understood that various modifications and changes can be made without departing from the scope of the present disclosure as defined in the appended claims.

With regard to further features and advantages of the present disclosure, reference is expressly made to the disclosure of the drawing.

### LIST OF REFERENCE SYMBOLS

1 Electrical machine
2 Main housing body
3 Stator housing
4 Stator
5 Support wall
6 Fastening element
7 Connection shaft
8 Rotor
9 Rolling bearing assembly
10 Inner side
11 Contact region
12 Fluidic connection structure
13 Electrical connection structure
14 Axis of rotation
15 Outer ring of the rolling bearing assembly
16 Inner ring of the rolling bearing assembly
17 Additional rolling bearing
18 Coil body
19a First stator half
19b Second stator half
20a First axial side
20b Second axial side
21 Through-opening
22 Support base
23 Housing
24 Outer wall
25 Intermediate wall
26 Gear connection
27 Centering extension
28 Receptacle
29 Thread region
30 Female threaded hole
31 Through-hole
32 Bearing journal
33 Shoulder of the bearing journal
34 Securing ring
35a First contact element
35b Second contact element
36 Securing element
37 Cover
38 Projection
39 Output shaft
40 Head
41 Shoulder of the connection shaft
42 Outer ring of the additional rolling bearing
43 Inner ring of the additional rolling bearing
44 Sleeve
45 Rotor position sensor
46a First rolling element raceway of the rolling bearing assembly
46b Second rolling element raceway of the rolling bearing assembly
46c Third rolling element raceway of the rolling bearing assembly
46d Fourth rolling element raceway of the rolling bearing assembly
47a First rolling element raceway of the additional rolling bearing
47b Second rolling element raceway of the additional rolling bearing
48 First rolling elements
49 Second rolling elements
50 Third rolling elements

1. An electrical machine for a motor vehicle drive comprising: a housing, a stator accommodated in the housing, and a rotor connected to a connection shaft for conjoint rotation, wherein the connection shaft is radially and axially supported toward a first axial side of the rotor by a rolling bearing assembly and is supported on a housing side toward a second axial side of the rotor facing away from the first axial side by an additional rolling bearing for transmitting at least axial forces.

2. The electrical machine according to claim 1, wherein the rolling bearing assembly includes a double-row rolling bearing or two single-row rolling bearings arranged directly axially adjacent to one another.

3. The electrical machine according to claim 1, wherein the rolling bearing assembly includes a double-row angular contact ball bearing or two single-row angular contact ball bearings or a double-row tapered roller bearing or two single-row tapered roller bearings or a combination of an angular contact ball bearing and a tapered roller bearing.

4. The electrical machine according claim 1, wherein a plurality of rolling element raceways of the rolling bearing assembly are aligned with one another in an O arrangement or X arrangement.

5. The electrical machine according to claim 1, wherein the rolling bearing assembly has at least one outer ring fixed both radially and axially to the stator or the housing and/or has at least one inner ring fixed both radially and axially to the connection shaft.

6. The electrical machine according to claim 1, wherein the additional rolling bearing enters into a radial clearance fit on an outer ring or an inner ring on a part of the stator or the connection shaft.

7. The electrical machine according to claim 1, wherein the additional rolling bearing includes an angular contact ball bearing or a tapered roller bearing.

8. The electrical machine according to claim 1, wherein rolling element raceways or force transmission directions of the additional rolling bearing are opposite with respect to rolling element raceways or force transmission directions of the rolling element assembly.

9. The electrical machine according to claim 1, wherein the electrical machine is an axial flux machine.

10. The electrical machine according to claim 1, wherein the stator has two disc-shaped stator halves, each having at least one coil body, wherein each stator half is accommodated in a stator housing and rotor is arranged axially between the stator halves.

11. A method of assembling an electrical machine for a motor vehicle drive, the method comprising:
providing a housing, a stator accommodated in the housing, and a rotor connected to a connection shaft for conjoint rotation;
supporting the connection shaft radially and axially toward a first axial side of the rotor by a rolling bearing assembly; and
supporting the connection shaft on a housing side toward a second axial side of the rotor facing away from the first axial side by an additional rolling bearing for transmitting at least axial forces.

12. The method of claim 11, wherein the rolling bearing assembly includes a double-row rolling bearing or two single-row rolling bearings arranged directly axially adjacent to one another.

13. The method of claim 11, wherein the bearing assembly includes a double-row angular contact ball bearing or two single-row angular contact ball bearings or a double-row tapered roller bearing or two single-row tapered roller bearings or a combination of an angular contact ball bearing and a tapered roller bearing.

14. The method of claim 11, wherein the rolling bearing assembly has at least one outer ring fixed both radially and axially to the stator or the housing and/or has at least one inner ring fixed both radially and axially to the connection shaft.

15. The method of claim 11, wherein a plurality of rolling element raceways of the rolling bearing assembly are aligned with one another in an O arrangement or X arrangement.

16. The method of claim 11, wherein the additional rolling bearing enters into a radial clearance fit on an outer ring or on an inner ring on a part of the stator or the connection shaft.

17. The method of claim 11, wherein the additional rolling bearing includes an angular contact ball bearing or a tapered roller bearing.

18. The method of claim 11, wherein rolling element raceways or force transmission directions of the additional rolling bearing are opposite with respect to rolling element raceways or force transmission directions of the rolling element assembly.

19. The method of claim 11, wherein the electrical machine is an axial flux machine.

20. The method of claim 11, wherein the stator has two disc-shaped stator halves, each having at least one coil body, wherein each stator half is accommodated in a stator housing and rotor is arranged axially between the stator halves.
